(19) United States
(12) Patent Application Publication
(10) Pub. No.: US 2026/0274759 A1
(43) Pub. Date: Sep. 17, 2026

(54) HIGHLY ABSORBANT MINERAL SPONGE

(71) Applicant: AMRIZE TECHNOLOGY SWITERLAND LLC, Zug (CH)

(72) Inventors: Fabrice Toussaint, Saint Quentin Fallavier (FR); Isabelle Dubois Brugger, Saint Quentin Fallavier (FR); Anthony Peuchlestrade, Saint Quentin Fallavier (FR); Isabelle Javierre, Saint Quentin Fallavier (FR)

(73) Assignee: AMRIZE TECHNOLOGY SWITERLAND LLC, Zug (CH)

(21) Appl. No.: 19/471,263

(22) PCT Filed: Mar. 29, 2024
(86) PCT No.: PCT/EP2024/058769

§ 371 Date: Sep. 30, 2025

(30) Foreign Application Priority Data
Mar. 30, 2023 (EP) 23165720.6

(51) Int. Cl. C04B 38/10; C04B 7/32; C04B 28/06; C04B 103/32; C04B 103/44; C04B 103/54; C04B 111/40; C04B 111/80

(52) U.S. Cl. CPC C04B 38/106; C04B 7/323; C04B 28/065; C04B 2103/32; C04B 2103/44; C04B 2103/54; C04B 2111/40; C04B 2111/802

(57) ABSTRACT

A highly absorbent mineral composition including 90 wt % or more, relative to the total weight of the absorbent mineral composition, of: cement, and a viscosity modifying agent, wherein the absorption capacity and/or the capillarity absorption of the absorbent mineral composition is typically of 50 wt % or more relative to the total weight of the absorbent mineral composition. A use of the absorbent mineral composition to improve evapotranspiration of construction materials or as an insulating material, or as a water retention material. A cement slurry leading to the absorbent mineral composition once cast and left to set, and to methods of preparing the cement slurry and absorbent mineral composition.

### FIELD OF THE INVENTION

The invention relates to a mineral “sponge” (absorbent mineral composition) with high water absorptive capacity, a cement slurry—which upon drying yields said mineral “sponge”, and the process for preparing said cement slurry and said mineral sponge. The absorbent mineral composition is useful as insulating material, as water retention material or depolluting material.

### BACKGROUND OF THE INVENTION

Evapotranspiration is a combination of evaporation and transpiration, measured in order to better understand crop water requirements, irrigation scheduling, and watershed management. The two key components of evapotranspiration are:
Evaporation: the movement of water directly to the air from sources such as the soil and water bodies. It can be affected by factors including heat, humidity, and wind speed,
Transpiration: the movement of water from root systems, through a plant, and exit into the air as water vapour. This exit occurs through stomata in the plant. Rate of transpiration can be influenced by factors including plant type, soil type, weather conditions and water content, and also cultivation practices.

Globally, it is estimated that on average between three-fifths and three-quarters of land precipitation is returned to the atmosphere via evapotranspiration.

The evapotranspiration cycle is primarily influenced by climatic factors:
the amount of water present;
the amount of energy present in the air and soil (e.g. heat); and
the ability of the atmosphere to take up water.

Secondary factors include in particular vegetation and humidity factors, soil permeability, or urban geometry.

Reduction of evapotranspiration in urban areas, in particular through extensive concreting which “seals” the soil, is known to contribute to higher temperatures during heat waves. Indeed, evapotranspiration allows to provide a cooling which can be quantified by considering the latent heat of water which is 2474 KJ/Kg at 20° C. As an example, the evaporation of 1 mm/h·m² (1 liter/m²) would give a cooling power of 2474×1000/3600=687 Watt/m².

City greening policies involving tree planting is important, but usually not efficient in the short term.

There is thus a need for new materials able to increase water absorption, in particular in urban areas.

The present invention thus aims to provide an absorbent mineral composition with improved absorption capacity and capillarity, suitable for use as insulating material or passive coolers or as support for green constructions. The absorbent mineral composition is also suitable for use under dry condition as insulating material. Further the absorbent material is suitable to be used as depolluting material for removing, at least in part, from the atmosphere gases and volatile compounds.

### SUMMARY OF THE INVENTION

In first aspect, the invention concerns an absorbent mineral composition comprising 90 wt % or more, preferably 95 wt % or more, relative to the total weight of the absorbent mineral composition, of:
cement, and
a viscosity modifying agent,
   wherein the absorption capacity (measured using the method described below) and/or the capillarity absorption (measured using the method described below) of the absorbent mineral composition is advantageously of 50 wt % or more, relative to the total weight of the absorbent mineral composition.

Advantageously, the absorbent mineral composition comprises 90 wt % or more, preferably 95 wt % or more, relative to the total weight of the absorbent mineral composition, of:
cement, and
a viscosity modifying agent,
   wherein the viscosity-modifying agent/cement mass ratio ranges from 0.1 to 0.8, and wherein the absorbent mineral composition preferably has an open porosity ranging from 55% to 85%.

In another aspect, the invention relates to a use of the absorbent mineral composition to improve evapotranspiration of construction materials or as an insulating material (or mineral cooling material).

The absorbent mineral composition of the invention provides the following advantages:
High water retention capability, and high capillarity absorption capacity, allowing for use as passive cooler (via a higher evaporation or transpiration rate),
Low density, due to its porous structure,
Excellent insulation capability, both thermally and acoustically.

In another aspect, the invention concerns a cement slurry comprising:
cement,
water, and
a viscosity modifying agent,
   with a water/cement mass ratio (hereinafter W/C) ranging from 1 to 5, preferentially 2 to 5, more preferably from 2 to 4.

In another aspect, the invention relates to a process for preparing cement slurry:
cement,
water, and
a viscosity modifying agent,
   with a water/cement mass ratio ranging from 1 to 5, preferentially 2 to 5, more preferably from 2 to 4, said process comprising:
a) Providing a cement or a cement premix,
b) mixing a viscosity modifying agent in water so as to obtain a solution with a yield stress value typically ranging from 0.1 to 1.0 Pa,
c) Adding the cement or cement premix of step a) to the solution of step b) so as to obtain a W/C ranging from 1 to 5, preferentially 2 to 5, more preferably from 2 to 4, and blending to obtain the cement slurry.
   or
a′) Providing a cement or a cement premix including a viscosity modifying agent,
b′) Adding the cement or cement premix including a viscosity modifying agent of step a′) to water so as to obtain a W/C ranging from 1 to 5, preferentially 2 to 5, more preferably from 2 to 4, and blending to obtain the cement slurry.

In another aspect, the invention relates to a process for preparing an absorbent mineral composition, comprising:
a) Preparing a cement slurry according to the process of the invention, and
b) Casting the cement slurry, and letting it set.

### Definitions

Total mass (or weight) of the absorbent mineral composition: As used herein, the “total mass (or weight) of the absorbent mineral composition” is understood as the total mass (or weight) of the composition in the dry state, i.e. the total mass (or weight) of the dry matter of the absorbent mineral composition. Indeed, the water content absorbed in the absorbent mineral composition may vary depending on a number of factors, including climatic conditions (for instance pluviometry, temperature, humidity, etc.). The absorbent mineral composition is in the dry state when its mass (or weight) remains constant. The total mass (or weight) of the absorbent mineral composition can be determined by drying the composition at 60° C. until its mass (or weight) remains constant, i.e. until the mass (or weight) difference between two weighings measured 24 hours apart, is of 0.5% or less.

Wt %: the wt % of a composition is calculated relative to the total weight of the composition, as defined above.

Mass %: the mass % of a composition is calculated relative to the total mass of the composition, as defined above.

Cement: The cement comprises Portland clinker and a source of calcium sulfate. The cement is preferably as defined in the standard NF-EN-197-1 of April 2012, or in the standard NF EN 197-5 published in May 2021. The cements defined in these standards are grouped in 6 different families: CEM I, CEM II, CEM III, CEM IV, CEM V and CEM VI. The cement can also be a CEM I, CEM II, CEM III, CEM IV, CEM V or a CEM VI to which mineral components are further added in a second preparation step. The cement may be any mineral binder that comprises Portland clinker optionally mixed with one or several mineral components as defined below. The cement may optionally further contain 10 wt.-% or less of a calcium aluminate cement or a calcium sulfoaluminate cement if shorter setting times and higher early age strength development are for example required.

Calcium sulphate: Calcium sulphate used according to the present invention includes gypsum (calcium sulphate dihydrate, CaSO₄·2H₂O), hemi-hydrate (CaSO₄·½H₂O), anhydrite (anhydrous calcium sulphate, CaSO₄) or a mixture thereof. Calcium sulphate produced as a by-product of certain industrial processes may also be used. Preferably, the calcium sulphate content ranges from 0% to 5% by weight of the cement.

Mineral component: the mineral component may designate slag (for example, as defined in the European NF EN 197-1 Standard of April 2012, paragraph 5.2.2), pozzolanic materials (for example as defined in the European NF EN 197-1 Standard of April 2012, paragraph 5.2.3), fly ash (for example, as described in the European NF EN 197-1 Standard of April 2012, paragraph 5.2.4), calcined schists (for example, as described in the European NF EN 197-1 Standard of April 2012, paragraph 5.2.5), material containing calcium carbonate, for example limestone (for example, as defined in the European NF EN 197-1 Standard paragraph 5.2.6), limestone components (for example, as defined in the “Concrete” NF P 18-508 Standard), silica fume (for example, as defined in the European NF EN 197-1 Standard of April 2012, paragraph 5.2.7), siliceous components (for example, as defined in the “Concrete” NF P 18-509 Standard), metakaolin or mixtures thereof. The mineral component may also be ground construction demolition waste.

Examples of siliceous components are ground glass, solid or hollow glass beads, glass granules, expanded glass powder.

Cement slurry: The expression “cement slurry” designates a mixture comprising water and cement. That cement slurry may also comprise additional components, as disclosed below. The terms “slurry of cement” and “cement slurry” have the same meaning and will be used interchangeably.

Essentially free of: As used herein, a material is “essentially free of” a particular component when the component is present in a very low content, usually 5% by weight or less, compared to the total weight of the material, more especially below 1% by weight. For instance, a cement is essentially free of sand when sand is present in the cement in an amount of less than 5 wt % or preferably 1 wt % of the total weight of cement.

Viscosity-modifying agent (or VMA): Viscosity modifying agents are able to modify yield stress, viscosity, and thixotropy of the cement slurry. VMAs are also known in the art as viscosity modifying admixtures, viscosity enhancing agents (VEAs), or stabilizing agents (SAs).

VMAs are usually biobased polymers, and include cellulose ethers, natural gums (xanthan, wellan, diutan) and starch and combinations thereof (see https://doi.org/10.1016/j.cemconres.2021.106646). For example, Mecellose® HiEND 2001 by LOTTE Fine Chemical is a suitable VMA for the present invention.

Absorption Capacity: As used herein, the “absorption capacity” is the mass % of water that an absorbent mineral composition is able to absorb when fully immersed under water for 1 hour.

It is measured using the protocol disclosed in the method part.

Capillarity Absorption: As used herein, the “capillarity absorption” is the mass % of water that an absorbent mineral composition is able to absorb by 10% of its volume is immersed under water for 1 hour.

It is measured using the protocol disclosed in the method part.

Yield stress: The yield strength or yield stress is a material property and is the shear stress corresponding to the yield point at which the material begins to deform plastically.

The yield strength is often used to determine the maximum allowable load in a mechanical component, since it represents the upper limit to forces that can be applied without producing permanent deformation.

Open Porosity: The open porosity refers to the ratio of the fluid volume occupied by the continuous fluid phase (air in the present invention) to the total volume of porous material. The open porosity differs from the “closed porosity” or “internal porosity”, which is the ratio of the volume of void space within the material that is not accessible from the exterior to the bulk volume. The open porosity is made of a network of connected pores. Open porosity may be measured by a variety of methods, preferably the mercury intrusion method as disclosed in the method part.

NOx: As used herein, “NOx” is shorthand for nitric oxide (NO) and nitrogen dioxide (NO2), the nitrogen oxides that are most relevant for air pollution. These gases contribute to the formation of smog and acid rain, as well as affecting tropospheric ozone.

### DETAILED DESCRIPTION OF EMBODIMENTS OF THE INVENTION

### 1. Absorbent Mineral Composition

The invention concerns an absorbent mineral composition comprising or essentially consisting of 90 wt % or more, preferably 95 wt % or more, even more preferably 98% or more, compared to the total weight of the absorbent mineral composition (in the dry state), of:
cement, and
a viscosity modifying agent,
   wherein the absorption capacity and/or the capillarity absorption of the absorbent mineral composition is typically of 50 wt % or more, relative to the total weight of the absorbent mineral composition.

### Cement

The cement has the definition provided above.

The cement as used in the invention may be any type of cement comprising Portland clinker, whatever its chemical composition is, and in particular whatever its alkaline content.

Therefore, one of the advantages of the invention is not having to select a specific type of cement. Advantageously, the cement used in the invention is selected from the cements readily available on the market.

Cements that are less or not suitable for the present invention are calcium aluminate cements and their mixtures used alone. Calcium aluminate cements are cements generally comprising a mineral phase C4A3$, CA, C12A7, C3A or C11A7CaF2 or their mixtures, such as, e.g., Ciment Fondu® (a calcium aluminate-based hydraulic binder), alumina cements, sulfoaluminate cements and calcium aluminate cements according to the European NF EN 14647 Standard of December 2006. Such cements are characterized by an alumina (Al₂O₃) content equal or lower than 35 wt.-%. However, calcium aluminate cements, calcium sulfoaluminate cements, or mixtures thereof, may be used in small amounts if for example shorter setting times or increased early age strength is desired. Calcium aluminate cements, calcium sulfoaluminate cements, or mixtures thereof, may not exceed 10 wt.-% relative to the total weight of cement.

Accordingly, preferably, the cement of the invention has an alumina (Al₂O₃) content lower or equal to 35 wt.-%.

As mentioned above, the cement may comprise mineral components as defined above. Suitable mineral components are preferably selected from calcium carbonate, silica, ground glass, solid or hollow glass beads, glass granules, expanded glass powders, silica aerogels, silica fume, slags, ground sedimentary siliceous sands, fly ash, calcined clays, pozzolanic materials, concrete demolition waste, ground construction demolition waste or mixtures thereof.

The mineral components are preferably in the form of particles having a Dv90 less than or equal to 200 μm, and more preferably a Dv97 less than or equal to 200 μm. Particle size can be measured by laser granulometry using for example a Malvern MS2000.

In a particular embodiment, the absorbent mineral composition comprises 85 wt % or more, preferably 90 wt % or more, of cement relative to the total weight of the absorbent mineral composition.

### Viscosity-Modifying Agent

The viscosity-modifying agent is as described above. Preferably, the viscosity modifying agent is an amphiphilic bio-based polymer.

In a particular embodiment, the VMA is a polymer derived from cellulose. Even more preferably the VMA is a cellulosic ether, such as Methyl Cellulose, MethylHydroxyEthyl Cellulose, HydroxyPropylMethyl Cellulose or mixture thereof. In a preferred embodiment, the VMA comprises or consists of xanthan gum or a polymer derived from xanthan gum, such as diutan gum. Mixtures of polymer derived from cellulose and of xanthan gum or a polymer derived from xanthan gum can also be contemplated.

Diutan gum is a natural high-molecular-weight gum produced by carefully controlled aerobic fermentation. The repeating unit is composed of a six-sugar unit. More specifically, the backbone of the repeating unit comprises d-glucose, d-glucuronic acid, d-glucose, and l-rhamnose, and the side chain of two l-rhamnose units. Diutan gum is commercially available under CAS number 125005-87-0.

Preferably, the viscosity-modifying agent/cement mass ratio ranges from 0.1 to 0.8, preferentially from 0.1 to 0.5.

### Additives

Optionally, the absorbent mineral composition further comprises up to 5% additives by weight relative to the weight of cement.

Advantageously, the additives are selected from the group consisting of:
a water reducer, such as a plasticizer or a superplasticizer, to avoid agglomeration during the preparation of the material,
an accelerator, to reduce the setting time of the slurry,
a super absorbent polymer, to improve the water retention and further improve the evapotranspiration phenomenon for example when the absorbent material is exposed to high temperatures or direct sunlight,
a pigment, in particular a light pigment, to increase the albedo phenomenon, and
mixtures thereof.

Advantageously, the absorbent mineral composition may further comprise a water reducer, such as a plasticiser or a superplasticizer. A water reducer makes it possible to reduce the amount of mixing water for a given workability by typically 10-15% by weight. Super-plasticisers are capable of reducing water contents of mixing water, for a given workability, by approximately 30% by weight.

By way of example of water reducers, mention may be made of lignosulphonates or gluconates, hydroxycarboxylic acids, carbohydrates, and other specific organic compounds, for example glycerol, polyvinyl alcohol, sodium alumino-methyl-siliconate, sulfanilic acid and casein as described in the Concrete Admixtures Handbook, Properties Science and Technology, V. S. Ramachandran, Noyes Publications, 1984.

By way of example of a superplasticizer, the PCP super-plasticisers without an anti-foaming agent may be noted. The term “PCP” or “polyoxy polycarboxylate” is to be understood according to the present invention as a copolymer of acrylic acids or methacrylic acids and their esters of polyoxy ethylene (POE) and/or polyoxy propylene. Preferably, the cement slurry comprises 0.05 to 0.5 wt.-%, more preferably 0.05 to 0.2 wt.-% of a water reducer, a plasticizer or a superplasticizer, percentage expressed by weight relative to the dry cement weight.

A water reducing agent contains a polymer and other chemicals and that enables the reduction by around 10 to 15% by weight the quantity of mixing water for a given slurry workability and rheology. As an example of water reducing agent may be cited lignosulphonates, hydroxycarboxylic acids, carbohydrates, and other specific organic compounds, such as for example glycerol, polyvinyl alcohol, sodium alumino-methyl siliconate, sulphanilic acid and casein (see Concrete Admixtures Handbook, Properties Science and Technology, V. S. Ramachandran, Noyes Publications, 1984).

Plasticizers are the first generation of water reducing agents. The amount of plasticizer generally depends on the cement reactivity. The lower its reactivity is, the lower amount of plasticizer is needed.

Superplasticizers belong to the new generation of water reducing agents and make it possible to reduce by around 30% by weight the quantity of mixing water for a given workability time. As an example of superplasticizer, it is possible to cite superplasticizers of PCP type that do not contain any antifoaming agent. The term “PCP” or “polycarboxylate polyoxide” is taken to mean according to the present invention a copolymer of acrylic acids or methacrylic acids; and their esters of poly(ethylene oxide) (POE). The amount of superplasticizer generally depends on the cement reactivity. The lower its reactivity is, the lower amount of superplasticizer is needed.

Preferably, the absorbent mineral composition comprises from 0.2 to 2.0%, more preferentially from 0.5 to 1.5%, by weight of a water reducing agent compared to the weight of cement. When the water reducing agent is used in solution, the quantity is expressed in g of active ingredient per 1 L of solution.

Advantageously, the absorbent mineral composition may further comprise a superabsorbent polymer.

A superabsorbent polymer (SAP) is a water-absorbing hydrophilic homopolymer or copolymer that can absorb and retain extremely large amounts of a liquid relative to its own mass. Super-Absorbent Polymers are crosslinked in order to avoid dissolution. There are three main classes of SAPs: 1) Cross-linked polyacrylates and polyacrylamides, 2) Cellulose- or starch-acrylonitrile graft copolymers, and 3) Cross-linked maleic anhydride copolymers. Examples of SAP are sodium polyacrylate and potassium polyacrylate.

Preferably, the absorbent mineral composition comprises from 0.2 to 2.0%, more preferentially from 0.5 to 1.5%, by weight of a superabsorbent polymer compared to the weight of cement.

Advantageously, the absorbent mineral composition may further comprise an accelerator (or accelerating agent). The accelerator is typically as defined in the standard NF EN 934-2 of September 2002. Suitable accelerators may for example be selected from:
calcium salts, potassium salts and sodium salts wherein the anion may be nitrate, nitrite, chloride, formiate, thiocyanate, sulphate, bromide, carbonate or mixtures thereof;
alkali silicates and aluminates, for example sodium silicate, potassium silicate, sodium aluminate, potassium aluminate or mixtures thereof.

Advantageously, it is present in an amount up to 0.5 to 3.0% by weight relative to the weight of cement.

Advantageously, the absorbent mineral composition may further comprise a pigment, in particular a pigment having a light color. Pigments can be natural or synthetic, organic or inorganic. Synthetic pigments are more stable and color fast. Examples of pigments are iron oxide (black, bround, red, yellow of varying particle size and shape), chromium oxide (green), titanium dioxide (white), phthalocyanine (blue, green). Pigments are usually provided as fine powders. As used herein, a “light color” is understood as a color providing a high Albedo effect, i.e. a color which allows a high percentage of the light to be reflected by the colored surface. A Light color is preferably selected from white, yellow and grey shades.

White pigments, such as titanium oxide, are particularly preferred. Yellow pigments, such as yellow iron oxides, or grey pigments such as ground or precipitated limestone, may also be used.

Advantageously, the absorbent mineral composition may further comprise activated carbon and/or biochar.

By “active carbon” or “activated carbon” is meant a material in the form of a powder mainly constituted of carbonaceous matter with a micro porous structure.

As used herein, the term “biochar” designates a solid porous carbonaceous material which is produced by thermal decomposition of biomass.

The term “biochar” designates a solid porous carbonaceous material which is produced by thermal decomposition of biomass. Biochar is obtained by the thermal decomposition of biomass at a temperature ranging from 350 to 1200° C., preferably from 350 to 800° C., more preferably from 400 to 750° C. and even more preferably from 450° C. to 700° C. Advantageously, the heat treatment is a pyrolysis carried out at a temperature of above 550° C., and advantageously below 750° C. or 700° C. The pyrolysis is typically performed in an oxygen-reduced atmosphere. Oxygen-reduced atmosphere is understood as an atmosphere with oxygen content below 21%. Advantageously, pyrolysis is performed in an oxygen reduced atmosphere with less than 10% oxygen in the atmosphere.

Advantageously, the activated carbon and/or biochar is present in an amount ranging from 0.1-5 wt. %, based on the composition of the absorbent mineral.

### Others

Typically the absorbent mineral composition is not a cementitious foam.

In particular embodiments, the absorbent mineral composition is essentially free of any expansion agent. Exemplary expansion agents are hydrogen peroxide, peroxomonosulphuric acid, peroxodisulfphuric acid, alkaline peroxides, alkaline earth peroxides, organic peroxide, particles of aluminium, or mixtures thereof. Other examples of expansion agents are calcium oxide, magnesium oxide, CSA or mixtures thereof.

In particular embodiments, the absorbent mineral composition is essentially free of any foam stabilizing agents.

In particular embodiments, the absorbent mineral composition is essentially free of polyvinyl alcohol, polyvinyl acetate or mixtures thereof.

Preferably, the addition of aggregates is not required. Aggregates include sand (whose particles generally have a minimum size (d min) greater than 0,063 mm and a maximum size (Dmax) of less than or equal to 2 or 4 mm), and gravel (whose particles generally have a minimum size (d min) greater than 4 mm).

Even more preferably, the absorbent mineral composition is essentially free of aggregates.

### Particular Embodiments

Advantageously, the absorbent mineral composition comprises or consist of, relative to the total weight of the absorbent mineral composition:
at least 85%, preferably at least 89.9%, even more preferably at least 94.5%, by weight of cement,
0.1 to 0.8%, preferentially 0.1 to 0.5% by weight, of a viscosity modifying agent such as diutan gum,
Up to 5% by weight of additives selected from the group consisting of a water reducer (such as a plasticizer or a superplasticizer), an accelerator, a superabsorbent polymer, a pigment (in particular a light pigment such as a white pigment), and mixtures thereof,
   wherein the absorption capacity of the absorbent mineral composition and/or the capillarity absorption of the absorbent mineral composition is typically of 80% or more, preferably 90% or more.

It is understood that the total of the components of the absorbent mineral composition cannot exceed 100%, and is equal to 100%.

### Absorbent Mineral Composition

Advantageously, the absorbent mineral composition has an absorption capacity of 80 wt %, preferably of 85 wt % or more, even more preferably of 100 wt % or more, relative to the total weight of the absorbent mineral composition.

Usually, the absorption capacity and capillarity absorption of the absorbent mineral composition is of 200 wt % or less, relative to the total weight of the absorbent mineral composition.

The absorbent mineral composition is porous. Typically, the absorbent mineral composition has an open porosity of at least 50%, preferably ranging from 55% to 85% or more.

The absorbent mineral composition of the invention also has excellent thermal properties, and in particular very low thermal conductivity. Thermal conductivity (also called lambda (A)) is a physical value characterizing the behavior of materials during the transfer of heat by conduction. Thermal conductivity represents the quantity of heat transferred per unit of surface and per unit of time submitted to a gradient of temperature. In the international system of units, thermal conductivity is expressed in watts per meter Kelvin (W/m·K). Preferably, the absorbent mineral composition according to the invention has a very good fire resistance.

Advantageously, the absorbent mineral composition is very efficient as an acoustic (or phonic) insulator.

The absorbent mineral composition typically has a good compressive strength compared with known mineral foams. The absorbent mineral composition has a compressive strength of between 0.04 to 1.5 MPa after 28 days, preferably from 0.05 to 1.2 MPa after 28 days, more preferentially from 0.1 to 1.1 MPa after 28 days.

The absorbent mineral composition is obtainable in particular from the cement slurry as described below, preferably according to the process described herein.

### 2. Absorbent Cement Slurry

The cement slurry comprises or essentially consists of:
cement,
water, and
a viscosity-modifying agent,
   with a water/cement mass ratio (hereinafter W/C) ranging from 1 to 5, preferentially 2 to 5, more preferably from 2 to 4, and
   preferably with a viscosity-modifying agent/cement mass ratio ranging from 0.1 and 0.8. In a particular embodiment, the cement slurry comprises 1% or less of sand and/or aggregates. Preferably, the cement slurry is essentially free of sand or aggregates.

Advantageously, the cement slurry is devoid of any expansion agent.

Advantageously, the cement slurry has a yield stress ranging from 0.1 to 1.0 Pa.

Preferably, the cement used for the absorbent mineral composition has an initial setting time ranging from 80 to 150 minutes, and a final setting time ranging from 150 to 250 minutes at room temperature, also when additional admixtures, including accelerators, are added.

### Cement

The cement is as described above in relation to the absorbent mineral composition.

In a particular embodiment, the cement slurry comprises between 15 wt. % and 50 wt.-%, preferably between 20 wt. % and 40 wt. %, of cement relative to the total weight of the cement slurry.

### Viscosity-Modifying Agent

The viscosity-modifying agent is as described above in relation to the absorbent mineral composition. Preferably, it comprises or consists of diutan gum.

Preferably, the viscosity-modifying agent/cement mass ratio ranges from 0.1 to 0.8 preferentially from 0.1 to 0.5.

### Water

The W/C ratio ranges preferably from 1 to 5, preferentially 2 to 4.

### Additives

Optionally, the cement slurry further comprises up to 5% additives by weight relative to the weight of cement. In other words, the additives/cement mass ratio is of 5% or less. The additives are as described above in relation to the absorbent mineral composition, and are advantageously selected from the group consisting of a water reducer (such as a plasticizer or a superplasticizer), an accelerator, a superabsorbent polymer, a pigment (in particular a light pigment such as a white pigment), and mixtures thereof.

Typically the absorbent mineral composition is not a cementitious foam.

In particular embodiments, the cement slurry is essentially free of any expansion agent. Exemplary expansion agents are hydrogen peroxide, peroxomonosulphuric acid, peroxodisulfphuric acid, alkaline peroxides, alkaline earth peroxides, organic peroxide, particles of aluminium, or mixtures thereof. Other examples of expansion agents are calcium oxide, magnesium oxide, CSA or mixtures thereof.

In particular embodiments, the cement slurry is essentially free of any foam stabilizing agents.

In particular embodiments, the cement slurry is essentially free of polyvinyl alcohol, polyvinyl acetate or mixtures thereof.

Advantageously, the cement slurry may further comprise activated carbon and/or biochar.

### Particular Embodiments

Advantageously, the cement slurry comprises or consist of:
cement,
0.01 to 0.5%, preferentially 0.1 and 0.4% by weight, of a viscosity modifying agent such as diutan gum, relative to the total weight of cement,
Up to 15%, preferably up to 5%, by weight of additives selected from the group consisting of a water reducer (such as a plasticizer or a superplasticizer), an accelerator, a superabsorbent polymer, a pigment (in particular a light pigment such as a white pigment), and mixtures thereof, relative to the total weight of cement,

Water,

with a water/cement mass ratio (or W/C) ranging from 1 to 5, preferentially 2 to 4.

### 3. Process for Preparing the Cement Slurry

Any conventional process for preparing a cement slurry is suitable to prepare the cement slurry of the invention.

However, preferably, the process to prepare the inventive cement slurry, which comprises or essentially consists of:
cement,
water, and
a viscosity modifying agent,
   with a water/cement mass ratio ranging from 1 to 5, preferably 2 to 4, said process comprises:
a) Providing a cement or a cement premix,
b) mixing a viscosity modifying agent in water so as to obtain an aqueous solution with a yield stress value typically ranging from 0.1 to 1.0 Pa,
c) Adding the cement or cement premix of step a) to the solution of step b) so as to obtain a W/C ranging from 1 to 5, and blending to obtain the cement slurry.

Alternatively, the process may comprise:
a′) Providing a cement or a cement premix including a viscosity modifying agent,
b′) Adding the cement or cement premix including a viscosity modifying agent of step a′) to water so as to obtain a W/C ranging from 1 to 5 (preferably 2 to 5, even more preferably 2 to 4), and blending to obtain the cement slurry.

The cement slurry may be blended and/or homogenized with water or the aqueous solution of step b) by any means to obtain a cement slurry. Preferably, step b′), or step (b) and/or step (c) is/are performed into a mixer, preferably equipped with deflocculating blades. Examples of suitable static mixers are disclosed in WO2022/122760 (p.14,l.10-27).

Preferably, the rotating speed in step (b) ranges from 200 to 400 rpm, preferably of 300 rpm. Advantageously, the rotating speed in step (c) or (b′) ranges from 500 to 800 rpm, preferably it is of 600 rpm.

In step (c) or (b′), blending is preferably performed until the slurry is homogeneous, i.e. the presence of flocs is not visually detectable.

Typically, the VMA is added to the solution of step (b) as a powder.

Advantageously, step (a) consists in providing a cement premix. A cement premix is a mixture of cement with solid additives, such as accelerators, water reducing agents, SAP, pigments, or mixtures thereof. This step is highly beneficial as it enables to reduce the preparation time of the cement slurry, and also reduces the water demand of the cement slurry.

Advantageously, the additives comprise a water reducing agent and/or a SAP. The water reducing agent and/or a SAP may then be added to the aqueous solution of step (b). The solid content of water reducing agents is typically ranging from 15% to 45%.

The cement premix then is then typically a mixture of cement with solid additives selected from accelerators, pigments, and mixtures thereof.

Alternatively, the water reducing agent and/or SAP is in powder form. In this alternative, the cement premix is a mixture of cement with water reducing agents and/or SAPs, and optionally with solid additives selected from accelerators, pigments, and mixtures thereof.

The cement slurry is then obtained by adding the premix to water (when the premix comprises VMA) or to a solution of VMA in water. The solution can further comprise the water reducing agent when the latter is in liquid form.

Preferably, in step (b), the cement slurry is continuously stirred to avoid any deposition from occurring.

Step (c) or (b′) may be performed continuously or discontinuously, preferably continuously.

Overall, the process may be a batch process or a continuous process. The person of skill in the art knows how to adapt the equipment in case of a continuous process.

The cement slurry of the invention may be pre-cast on the jobsite (for instance by installing a mixer on the jobsite), a ready-mix cement slurry or produced at a production plant of precast elements. Preferably, the cement slurry is a ready-mix cement slurry.

The invention also relates to a cement slurry obtainable and/or obtained according to the process of the invention.

### 4. Preparation and Uses of the Absorbent Mineral Composition

In another aspect, the invention relates to a process for preparing an absorbent mineral composition, comprising:
a) Preparing a cement slurry according to the process of the invention described above,
b) Casting the cement slurry, and
c) Curing it or leaving it to set.

Advantageously, the inventive process does not need any autoclave step, or thermal treatment step (for example at 60-80° C.) in order to obtain an absorbent mineral composition.

The curing can be performed at ambient temperature (20° C.).

Setting and drying time may be reduced depending on the presence and amount of accelerator added to the cement premix.

The invention also relates to an absorbent mineral composition obtainable and/or obtained according to the process of the invention.

### 5. Uses

In another aspect, the invention relates to a use of the absorbent mineral composition as an insulating material, or to improve evapotranspiration of construction materials. In the latter case, the absorbent mineral composition may be regarded as a “mineral cooling material”.

As an insulating material, the absorbent mineral composition is relevant for construction materials. The building material is advantageously capable of withstanding or reducing air and thermo-hydric transfers, that is to say this element has a controlled permeability to transfers of air, of water in the form of vapor or liquid.

The invention thus also refers to a method for insulating a construction, by inserting the absorbent mineral composition into a construction part. The inserting may be performed in any adapted way. Preferably, in this embodiment, the absorbent mineral composition is dry, or has been dried before use.

In another aspect, the invention relates to a use of the absorbent mineral composition of the invention for removing (at least in part) from the atmosphere gases and volatile compounds including nitrogen oxides, preferably NOx, sulfur oxides, volatile organic compounds, ozone or carbon monoxide, more preferably NOx, even more preferably NO₂.

The invention also relates to a method for depolluting the atmosphere (at least in part), or for withdrawing NOx from the atmosphere (at least in part), comprising trapping, in particular absorbing, atmosphere gases and volatile compounds including nitrogen oxides, and preferably NOx, sulfur oxides, volatile organic compounds and ozone, more preferably NOx, even more preferably NO₂, in a building or construction comprising the pervious concrete of the invention.

The invention further relates to a method for depolluting the atmosphere (at least in part), or for withdrawing NOx from the atmosphere (at least in part) in a zone to be depolluted, comprising manufacturing a building or a construction located in the zone to be depolluted with the pervious concrete of the invention.

### Methods

### Measurement of Absorption Capacity

A cement slurry of the invention is typically cast in a cubic mold of 10 cm*10 cm*10 cm dimensions.

The cement slurry is cured for 28 days at 20° C. and 100% relative humidity to give an absorbent mineral composition. The absorbent mineral composition is then dried at 60° C. until its mass remains constant, i.e., until the mass difference between two measurements measured 24 hours apart, is of 0.5% or less. A dried and cured absorbent mineral composition sample is thus obtained. 1

The dried and cured absorbent mineral composition sample is fully immersed and maintained under the water surface (where appropriate using weighs so it does not float) into a water tank for one hour. The “wet” absorbent mineral composition sample is then removed and put on a wet tissue to remove excess water, before measuring its mass. The absorption capacity is expressed as %, and is calculated using the following formula:

$${Abs}_{capacity} = 100 \times ( {M}_{wet} - {M}_{dried} ) / {M}_{dried} )$$

wherein M_{dried} is the mass of the dried and cured absorbent mineral composition, and
M_{wet} is the mass of the “wet” absorbent mineral composition.

### Measurement of Capillarity Absorption

A dried and cured absorbent mineral composition sample is prepared as described previously for absorption capacity.

The dried and cured absorbent mineral composition sample is put in an empty tank, and water is added up to 1 cm height. The dried and cured absorbent mineral composition sample is maintained in water (where appropriate using weighs so the dried and cured absorbent mineral composition sample does not float) for one hour. The “humid” absorbent mineral composition sample is then removed from the tank.

The capillarity absorption is expressed as %, and is calculated using the following formula:

$${Abs}_{capillarity} = 100 \times ( {M}_{humid} - {M}_{dried} ) / {M}_{dried} )$$

wherein M_{dried} is the mass of the dried and cured absorbent mineral composition, and
M_{humid} is the mass of the “humid” absorbent mineral composition.

### Measurement of Open Porosity

The open porosity of the material is measured by mercury intrusion using a penetrometer. Low and high pressures are applied for mercury to penetrate into the material. The volume of mercury that penetrates into the sample at the end of the experiment must be between 25% and 90% of the penetrometer.

The measurement of open porosity is related to the Washburn equation (1) which relates the pressure applied to the pore diameter:

$$D = - ( 1 / P ) 4 ( γ ) cos ( θ ) \qquad ( 1 )$$

wherein D is the pore diameter, P is the pressure applied, γ is the surface tension of mercury (0.485 N/m) and θ is the contact angle of mercury (130°)

Mercury is used because it has a high contact angle (it is a non-wetting liquid). The volume of penetrated mercury is measured as a function of the pressure applied to the material. Washburn's equation relates pressure to pore diameter. This diameter corresponds to the entrance diameter of the pore.

Standard DIN ISO 15901-1 of March 2019 provides a full description of the measurement method of open porosity.

### Measurement of Thermal Conductivity

Thermal conductivity is measured following the protocol given in ASTM C1113 (2019).

### Measurement of Setting Time

The setting time is measured according to the standard NF EN 196-3 published in January 2009.

### Measurement of the Yield Stress

The yield stress represents the minimum of shear stress to be applied to the material before flowing. It is measured with a 4-cross blade, known as a vane. The yield stress is a function of the vane diameter (D) and height (H) and the vane is rotated at a low velocity so that the maximum torque doesn't depend on the viscosity.

The vane has a diameter of 40 mm, and a height of 55 mm, the velocity is 0.1 rpm. The measurement begins 1 minute after the introduction of the blade in the material. The maximum value of the stress is then reported and considered as the static yield stress.

### Method for Measuring the Compressive Strength (Cs) of the Absorbent Mineral Composition:

A cement slurry of the invention is typically cast in a mold. The cement slurry is cured for 28 days at 20° C. and 100% relative humidity to give a cured absorbent mineral composition. Cubic samples (dimensions 4 cm*4 cm*4 cm) are used for measuring the compressive strength.

A mini press is used for measuring low resistances, which are measured according to the standard NF EN 826 of May 2013.

### Adsorption Test Method:

NOₓ gas adsorption tests were performed using a fused quartz reactor (3.8 dm3). The gas was injected into the reactor via 5 holes to homogenize the flow pattern. The NO/NO2 concentration inlet (respectively 768 μg/m3 NO and 478 μg/m3 NO₂) and outlet streams were controlled with an automatic NOₓ gas analyser (AC32M from Environnement SA, France). The mixed two gases were injected via a nitrogen carrier, with controlled relative humidity (45%). The instantaneous percentage reduction in pollutant gas concentration is expressed as AEₚₒₗₗᵤₜₐₙₜ=[(C₀−Cₛₐₘₚₗₑ)/Cᵢₙₗₑₜ)*100], wherein:

AEₚₒₗₗᵤₜₐₙₜ stands for “adsorption efficiency” for pollutant (NO or NO2).

C₀ and Cₛₐₘₚₗₑ are the simultaneous concentrations of the pollutant, at the outlet of the bypass and of the reactor containing the solid sample, respectively.

Samples were exposed in the chamber over a period of 24 hours. The size of the samples is 15 cm*15 cm*5 cm with only the top surface exposed to the pollutants stream (all other surfaces are blocked with sealer).

The performance can also be expressed as a percentage by summing/integrating the instantaneous mitigation value over twenty four hours.

### DESCRIPTION OF THE FIGURES

FIG. 1: NO₂ mitigation performance for absorbent mineral composition. The vertical axis corresponds to the ratio [NO2]/[NO2] inlet. The horizontal axis corresponds to the time (in h).

### EXAMPLES

### Materials

The cement used is a CEM|52.5 N supplied by the Lafarge plant of Val d'Azergues in France.

The viscosity-modifying agent (VMA) is Kelcocrete DG (DG stands for diutan gum) supplied by BASF as a powder.

The accelerator is Denka SC1 (calcium aluminate-based accelerator) supplied by Denka as a powder.

Water: tap water

### Equipment

### The Rayneri Mixer:

A Turbotest mixer (MALX-0266-2019/12) supplied by the company Rayneri, which is a mixer with a vertical axis equipped with a deflocculating blade.

### Preparation of the Cement Slurry

For preparing one liter of slurry, the following composition was used:

TABLE 1

| | Accelerator/Cement | | VMA/Cement | |
|---|---|---|---|---|
| MIX | (in wt %) | VMA (g) | ratio (in wt. %) | W/C |
| 1 | — | 3 | 0.2% | 2 |
| 2 | — | 3 | 0.3% | 3 |
| 3 | — | 4 | 0.4% | 4 |
| 4 | 5% | 3 | 0.21% | 2 |
| 5 | 5% | 3 | 0.32% | 3 |
| 6 | 5% | 4 | 0.42% | 4 |

The cement slurry was prepared using a mixer Rayneri Turbotest 33/300 equipped with a deflocculating blade, into which tap water was first introduced.

Then, while mixing at 300 rpm, VMA (diutan gum) was added. The aqueous solution was continuously stirred until having a yield stress value between 0.1 and 1.0 Pa.

While mixing at 600 rpm, the solid components were progressively added, preferably over 1 minute. The cement slurry was then mixed for two additional minutes, until no flocs were visually detectable.

### Results

The results are presented in the following table.

TABLE 2

| | | | Compressive | | | |
|---|---|---|---|---|---|---|
| | | | strength at | Absorption | Capillary | Evaporation |
| | | W/C | 28 days | capacity | absorption | rate |
| MIX | Description | ratio | (MPa) | (wt.-%) | (wt.-%) | (mm/day) |
| 1 | E/C 2 | 2 | 1.08 | 90 | 91.0 | N.M. |
| 2 | E/C 3 | 3 | 0.21 | 154 | 142 | 6.0 |
| 3 | E/C 4 | 4 | <0.05 | 209 | 207 | N.M. |
| 4 | E/C 2 + | 2 | 1.03 | 100 | 96 | N.M. |
| | accelerator | | | | | |
| 5 | E/C 3 + | 3 | 0.35 | 154 | 128 | N.M. |
| | accelerator | | | | | |
| 6 | E/C 4 + | 4 | 0.25 | 196 | 158 | N.M. |
| | accelerator | | | | | |
| Ref 1 | Lawn | N.M. | N.M. | N.M. | N.M. | 1.95 |
| Ref 2 | Soil + grass | N.M. | N.M. | N.M. | N.M. | 5.35 |
| | water | | | | | 10 |

N.M.: value not measured.

### Example

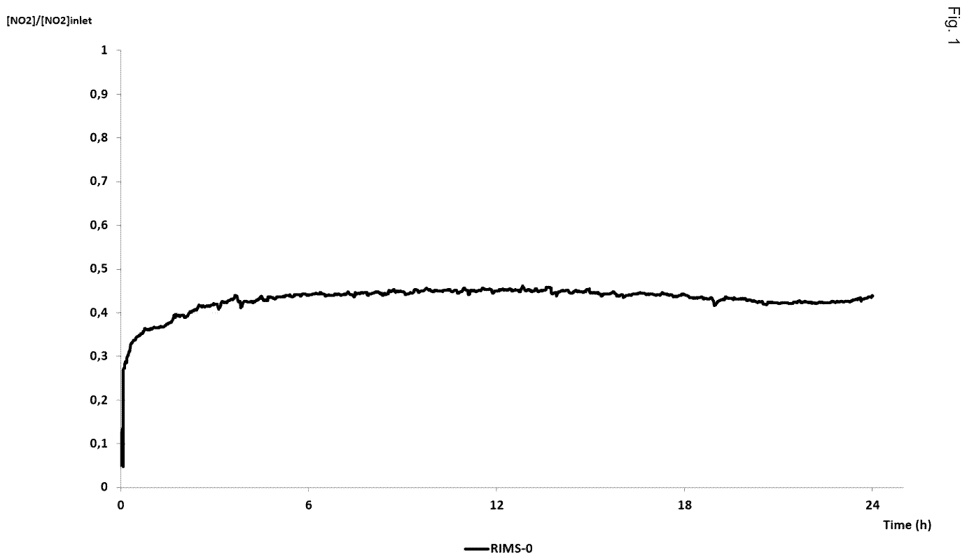

FIG. 1 presents the depolluting performance of the absorbent mineral composition (mix design. No. 2) for NO2 gas pollutant. The following Table demonstrates the measured mitigation performance.

TABLE 3

| | NO2 mitigation |
|---|---|
| | performance (%) |
| Absorbent mineral | 57 |
| composition according | |
| to invention (Mix | |
| design 2) | |

1. An absorbent mineral composition comprising 90 wt % or more, relative to the total weight of the absorbent mineral composition in the dry state, of:
cement, and
a viscosity modifying agent,
wherein the absorption capacity and/or the capillarity absorption of the absorbent mineral composition is 50 wt % or more, relative to the total weight of the absorbent mineral composition.

2. A cement slurry comprising:
cement,
water, and
a viscosity modifying agent,
with a water/cement mass ratio (W/C) ranging from 2 to 5.

3. The absorbent mineral composition of claim 1, wherein the cement comprises up to 10 wt.-% of calcium aluminate cements, calcium sulfoaluminate cements, or mixtures thereof, relative to the total weight of cement.

4. The absorbent mineral composition of claim 1 wherein the cement comprises mineral selected from the group consisting of calcium carbonate, silica, ground glass, solid or hollow glass beads, glass granules, expanded glass powders, silica aerogels, silica fume, slags, ground sedimentary siliceous sands, fly ash, calcined clays, pozzolanic materials, concrete demolition waste, ground construction demolition waste or mixtures thereof.

5. The absorbent mineral composition of claim 1 wherein the viscosity-modifying agent comprises or consists of cellulosic ethers, xanthan gum, or a polymer derived from xanthan gum.

6. The absorbent mineral composition of claim 1 wherein the viscosity-modifying agent/cement mass ratio ranges from 0.1 to 0.8.

7. The absorbent mineral composition of claim 1 wherein it comprises up to 5% by weight of additives selected from the group consisting of a water reducer, an accelerator, a superabsorbent polymer, a pigment, and mixtures thereof, relative to the total weight of absorbent mineral composition.

8. The absorbent mineral composition of claim 7, wherein it comprises a white pigment, and/or a superplasticizer.

9. The absorbent mineral composition of claim 1, wherein:
it comprises 98 wt % or more of cement and viscosity-modifying agent (VMA) relative to the total weight of the absorbent mineral composition in the dry state, and/or
it is essentially free of sand or aggregates.

10. The absorbent mineral composition claim 1, wherein it has an open porosity ranging from 55% to 85%.

11. A method comprising inserting the absorbent mineral composition of claim 1 into construction materials to improve evapotranspiration of the construction materials or to perform as an insulating material.

12. A method comprising removing, at least in part, from the atmosphere gases and volatile compounds including nitrogen oxides, sulfur oxides, volatile organic compounds, ozone or carbon monoxide with the absorbent mineral composition of claim 1.

13. A process for preparing the cement slurry of claim 2, said process comprising:
a) Providing the cement or a cement premix,
b) mixing the viscosity modifying agent in water so as to obtain a solution with a yield stress value ranging from 0.1 to 1.0 Pa,
c) Adding the cement or cement premix of step a) to the solution of step b) so as to obtain a W/C ranging from 1 to 5, and blending to obtain the cement slurry.

14. A process for preparing the cement slurry of claim 2, said process comprising:
a′) Providing the cement or a cement premix including the viscosity modifying agent,
b′) Adding the cement or cement premix including the viscosity modifying agent of step a′) to water so as to obtain a W/C ranging from 1 to 5, and blending to obtain the cement slurry.

15. A process for preparing the absorbent mineral composition of claim 1, comprising:
a) Preparing a cement slurry by providing the cement or a cement premix, mixing the viscosity modifying agent in water so as to obtain a solution with a yield stress value ranging from 0.1 to 1.0 Pa, and adding the cement or cement premix of to the solution so as to obtain a W/C ratio ranging from 1 to 5, and blending to obtain the cement slurry,
b) Casting the cement slurry, and
c) Curing it or leaving it to set to form the absorbent mineral composition.

16. The cement slurry of claim 2, wherein the cement comprises:
up to 10 wt.-% of calcium aluminate cements, calcium sulfoaluminate cements, or mixtures thereof, relative to the total weight of cement

17. The cement slurry of claim 2, wherein the cement slurry comprises:
up to 5% by weight of additives selected from the group consisting of a water reducer, an accelerator, a superabsorbent polymer, a pigment, and mixtures thereof, relative to the total weight of the weight of cement.

18. The cement slurry of claim 2, wherein the cement comprises mineral selected from the group consisting of calcium carbonate, silica, ground glass, solid or hollow glass beads, glass granules, expanded glass powders, silica aerogels, silica fume, slags, ground sedimentary siliceous sands, fly ash, calcined clays, pozzolanic materials, concrete demolition waste, ground construction demolition waste or mixtures thereof.

19. The cement slurry of claim 2, wherein the viscosity-modifying agent/cement mass ratio ranges from 0.1 to 0.8 and the viscosity-modifying agent comprises or consists of cellulosic ethers, xanthan gum, or a polymer derived from xanthan gum, such as diutan gum.

20. The cement slurry of claim 2, wherein the cement slurry comprises a white pigment, and/or a superplasticizer.
